(19) United States
(12) Patent Application Publication
(10) Pub. No.: US 2026/0111674 A1
(43) Pub. Date: Apr. 23, 2026

(54) LLM-BASED CONVERSATIONAL ARTIFICIAL INTELLIGENCE SLOT FILLING BACKGROUND

(71) Applicant: International Business Machines Corporation, Armonk, NY (US)

(72) Inventors: Haode Qi, Cambridge, MA (US); Eric Donald Wayne, Raleigh, NC (US); Kyle Croutwater, Chapel Hill, NC (US); Cheng Qian, Toronto (CA); Pratyush Singh, Plano, TX (US); Mohammadreza Fazeli, Toronto (CA); Zhongzheng Shu, Malden, MA (US)

(21) Appl. No.: 18/922,870

(22) Filed: Oct. 22, 2024

(51) Int. Cl. G06F 40/30

(52) U.S. Cl. CPC G06F 40/30

(57) ABSTRACT

A system includes a processor that executes computer executable components stored in a memory. The computer executable components can comprise a prompt generation component that builds, based on usage logs, a ranking of slots, for filling in conversations, and dynamically and incrementally prompts a subset of slots based on the ranking for a virtual assistant. The computer executable components comprise a hybrid grounding component that grounds information pertaining to the subset of slots for the virtual assistant, wherein the hybrid grounding component utilizes intent determination to fill one or more of the slots.

### BACKGROUND

The subject disclosure relates to LLM-based conversational artificial intelligence slot filing, e.g., hybrid dialog slot filling architecture that allows users to build a ranking of slots from scratch or by using previously existing content.

Slots are pieces of information in a conversation session that need to be filled in by an end user so that the virtual agent can perform a task (e.g. respond to an informational query or call an API, such as first name, last name, address, order, etc.). Robust slot filling needs to handle many ways humans describe information. Even everyday fields such as dates and numbers can be expressed in many ways.

While large language models (“LLMs”) have shown the ability to detect slots and transform extracted information into JavaScript Object Notation (“JSON”) as needed by a virtual agent system, challenges still remain. For example, traditional slot filling models rely on training entity models specific to a use case, creating dictionary-based entities, and rule-based systems, while more recent dialogue state tracking models are task specific.

Existing virtual assistant (“VA”) systems have rule-based slot filling, and are usually limited to specific well-known types. For example, a set of rules correspond to how to map information in a user request to date, time, location, etc. slot types. These rules can offer precision but lack the ability to generalize well. They are also expensive to maintain and are often language specific. Furthermore, existing VA systems have difficulty filling multiple slots of the same type, and are prone to ambiguity. They fill one slot at a time, requiring users to answer a prompt filling question step by step. This is an unnatural experience in a conversational system, as users prefer the ability to provide multiple pieces of information in a single sentence. Furthermore, existing LLM-based solutions do not always produce reliable outputs, and are prone to hallucinations.

### SUMMARY

The following presents a summary to provide a basic understanding of some embodiments of the invention. This summary is not intended to identify key or critical elements or delineate any scope of the particular embodiments or any scope of the claims. Its sole purpose is to present concepts in a simplified form as a prelude to the more detailed description that is presented later. In some embodiments described herein, systems, computer-implemented methods, and/or computer program products that facilitate LLM-based conversational AI slot filling are provided.

According to an embodiment, a system can comprise a processor that executes computer executable components stored in memory. The computer executable components can comprise a prompt generation component that builds, based on usage logs, a ranking of slots, for filling in conversations, and dynamically and incrementally prompts a subset of slots based on the ranking for a virtual assistant. The computer executable components comprise a hybrid grounding component that grounds information pertaining to the subset of slots for the virtual assistant, wherein the hybrid grounding component utilizes intent determination to fill one or more of the slots.

According to another embodiment, a computer-implemented method can comprise building, based on usage logs, by a system operatively coupled to a processor, a ranking of slots for filling in conversations. The computer-implemented method further comprises dynamically and incrementally prompting a subset of slots, based on the ranking, by a system, for a virtual assistant. The computer-implemented method further comprises grounding, by a system, information pertaining to the subset of slots for the virtual assistant, wherein the grounding utilizes intent determination to fill one or more of the slots.

According to another embodiment, a computer program product comprising a computer readable storage medium having program instructions embodied therewith, the program instructions executable by a processor to cause the processor to build, by the processor, a ranking of slots, and prompt slots basted on the ranking. The program instructions can also cause the processor to ground, by the processor, information pertaining to the slots. The program instructions can also cause the processor to train, by the processor, a large language model to detect the grounded information. The program instructions can further cause the processor to use, by the processor, the detected information to generate steps for a virtual assistant to follow to fill the slots.

### BRIEF DESCRIPTION OF THE DRAWINGS

FIGS. 1 and 2 illustrate example systems that can facilitate LLM-based conversational AI slot filling in accordance with some embodiments described herein.

FIGS. 3 and 4 illustrate example computer-implemented methods that utilize a processor that executes computer executable components stored in memory to facilitate LLM-based conversational AI slot filling in accordance with some embodiments described herein.

FIGS. 5-9 illustrate example flow diagrams in accordance with some embodiments described herein.

FIG. 10 illustrates a block diagram of an example computing environment in which some embodiments described herein can be facilitated.

### DETAILED DESCRIPTION

The following detailed description is merely illustrative and is not intended to limit embodiments, applications, and/or uses of embodiments. Furthermore, there is no intention to be bound by any expressed or implied information presented in the preceding Background or Summary sections, or in the Detailed Description section.

Slot filling is a critical aspect of conversational AI and virtual assistant (VA) systems. It involves identifying and extracting specific pieces of information from user input that are essential for fulfilling a given task. For example, in an interaction where a user asks to book a flight, the virtual agent might need to extract slots such as the departure city, destination, travel date, and passenger count. These pieces of information must be identified and filled accurately to ensure that the agent can proceed with the task. Traditionally, slots represent entities like names, dates, numbers, or even more abstract types of information, such as intent (e.g., booking a hotel or canceling a reservation).

One of the primary challenges in slot filling is the diversity in how humans express the same information. For instance, a date can be provided as “next Monday,” “September 25th,” or “in three days.” Likewise, a user's address or time of day can be spoken in various ways, each of which needs to be correctly interpreted by the virtual assistant. As conversational interfaces strive to become more natural and human-like, the ability to robustly handle these variations in language becomes paramount. This has led to the growing use of Large Language Models (LLMs) in VA systems, given their ability to generalize and handle a wide range of linguistic input.

Early slot filling systems were based on rule-based methods or dictionary-based entities. These systems are often tailored to specific use cases or domains and rely on predefined rules to map user input to the required slots. Rule-based systems can be highly precise within their domain, but they are not scalable to the variety of user requests across different fields or languages. In more recent approaches, dialogue state tracking models have been developed to predict user intent and fill the corresponding slots based on conversational context. However, these models are still task-specific, meaning they must be retrained or fine-tuned for each new application. The effort required to maintain these models is high, and they often fail to generalize well to more open-ended or less structured conversations.

LLMs have the potential to improve slot filling significantly. These models can handle a wider range of linguistic expressions and provide the flexibility to extract information from complex or ambiguous inputs. Instead of relying on a predefined list of rules, they can process a sentence in its entirety, making inferences about the user's intent and identifying the relevant slots in a single pass. Once extracted, the information can be structured in JavaScript Object Notation (JSON), a format widely used by virtual assistant systems to interact with APIs and backend services. Despite the advancements offered by LLMs, challenges persist in the current state of slot filling technology. For example, traditional slot-filling methods, while precise, are often constrained by their inability to generalize. Rule-based models, for instance, are typically limited to well-defined types such as dates, times, or locations. When the user's input deviates from these predefined categories or when dealing with more nuanced or domain-specific data, such systems tend to fail. Even when successful, rule-based methods require ongoing updates and maintenance, making them expensive and impractical at scale.

Furthermore, many virtual assistants struggle to handle multiple slots of the same type. For example, if a user says, “book a flight for me and my friend from New York to Atlanta, and from Los Angeles to Seattle,” existing systems would often find it difficult to extract multiple departure cities and destinations in one pass. This forces the assistant to prompt the user repeatedly, asking for information slot by slot, which can create an unnatural and frustrating user experience. Additionally, slot-filling models often focus on the sequential completion of slots, rather than interpreting a user's input holistically, limiting their effectiveness in natural conversation scenarios where people prefer to convey multiple pieces of information concurrently.

Another significant issue with current LLM-based slot filling is their occasional unreliability. While LLMs are powerful, they can sometimes “hallucinate,” generating information or making inferences that are not present in the user's input. In a slot-filling context, this can lead to erroneous or misleading outputs, especially in cases where clarity is critical, such as in financial transactions or medical queries. This propensity for hallucination reduces the trustworthiness of LLM-based systems, especially in high-stakes applications.

To overcome these challenges, several improvements are required. First, more robust, generalized models that can handle multiple slot types concurrently and can fill multiple slots in a single interaction are essential. These models should be capable of understanding and extracting complex, nested information from a single utterance without relying on rule-based systems or task-specific training. Moreover, there is a need for hybrid approaches that combine the precision of rule-based systems with the flexibility and adaptability of LLMs. By leveraging domain-specific rules to enhance accuracy while using LLMs to generalize across broader conversations, VA systems could achieve both reliability and scalability. This hybrid approach could also help reduce hallucinations by constraining the model's output based on predefined rules for critical slots.

In relation to LLM-based conversational artificial intelligence slot filing, embodiments of the present disclosure produce a solution to one or more of these problems. These embodiments may solve such problems by building a ranking of slots, prompting slots basted on the ranking, grounding information pertaining to the slots, and training a large language model to detect the grounded information. The embodiments may also include detecting information to generate steps for a virtual assistant to follow to fill the slots.

According to an embodiment, a system can comprise a processor that executes computer executable components stored in memory. The computer executable components can comprise a prompt generation component that builds, based on usage logs, a ranking of slots, for filling in conversations, and dynamically and incrementally prompts a subset of slots based on the ranking for a virtual assistant. The computer executable components comprise a hybrid grounding component that grounds information pertaining to the subset of slots for the virtual assistant, wherein the hybrid grounding component utilizes intent determination to fill one or more of the slots.

In some embodiments, the system further comprises a hybrid authoring component that generates steps for the virtual assistant to follow.

In some embodiments, the system further comprises an artificial intelligence component that trains a large language model to detect the grounded information. In some embodiments of the system, the artificial intelligence component utilizes the detected information to fill slots.

In some embodiments of the system, the prompt generation component performs the ranking by employing a machine learning (“ML”) model with an objective function of predicting the subset of slots to prompt given a current conversation and a frequency of slots filled on previous utterances.

In some embodiments, the hybrid grounding component determines at least one of: detected intent, detected entities, context of a conversation, session history, goal statement, format constraints regarding one or more slots, business policy constraints, application programming interface (API) call or environment information, previous error results, or feedback from a human user.

In some embodiments of the system, the hybrid grounding component integrates natural language processing results of a trained virtual assistant into the grounding of information pertaining to respective slots.

In some embodiments, the prompt generation component builds the ranking of slots based at least in part on usage logs.

In some embodiments, the prompt generation component optimizes the system to reduce load and runtime latency, and to limit hallucinations. According to some embodiments, instead of prompting the LLM for all slots each time, the prompt generation component fills in slots in an incremental, accumulative manner.

Advantages of this system may include increased reliability, accuracy, and format precision when filling in slots, faster response time, and reduced cost. Advantages of this system further include increased control and visibility when filling in slots.

According to some embodiments, the above-described computer system may be implemented as a computer-implemented method or as a computer program product.

The hybrid dialog slot filling architecture described herein allows users to build from scratch or to use previous existing content. The architecture includes dynamic prompt generation, based upon existing dialogue runtime, which limits hallucinations and reduces load and runtime latency. A given user dialogue may contain numerous conditions that can be used to develop a decision tree. However, not every piece of dialogue (and not every condition) may be relevant at a given time. For example, some conditions may be immediately relevant, whereas others may only become relevant at a later time. Dynamic prompt generation reduces the amount of information presented to the LLM to only that which is relevant at a given time, thereby reducing the risk of hallucination and load and runtime latency.

The architecture further includes hybrid grounding. A major concern with LLMs is the possibility for derailment (for example, producing unexpected outputs). Grounding utilizes an existing user system to help guide an LLM in its decision-making process. LLMs excel at understanding natural language input in a broader context. They can process the nuances, ambiguities, and variations in user queries better than traditional NLP systems. By incorporating grounding, the LLM can better tie its interpretation of the user's intent to real-world entities, concepts, or actions. This reduces the risk of misinterpreting a user's input when filling dynamic slots. Traditional NLP/ML techniques are often more predictable and structured compared to LLMs. These techniques (like rule-based or statistical methods) can handle known and well-defined slot-filling tasks efficiently and reliably. When combined with LLMs, traditional systems can serve as a backbone for consistent tasks, while the LLM handles more dynamic, ambiguous, or out-of-domain cases. The ability to dynamically switch between traditional NLP and LLM-based processing optimizes speed, computational cost, and accuracy. Hybrid grounding ensures that generated slots are not arbitrary but aligned with the user's intended context, reducing the likelihood of error.

The architecture further includes hybrid authoring. Occasionally, a user may provide new or unexpected information (i.e., new requirements) that necessitate the creation of new slots. If new slots do emerge during a conversation, the LLM can identify and create the new slots on the fly. With grounding, the architecture can ensure that newly generated slots are not arbitrary but aligned with the user's intended context, reducing the likelihood of error. However, instances could emerge where a user does not wish to assume the risk of inaccuracy of an LLM, and would instead prefer to rely on traditional NLP/ML techniques. The hybrid dialog slot filling architecture described herein allows users to author however they may prefer. Thus, a user could use traditional content that is compatible with the LLM, or produce content with the LLM that is compatible with traditional content.

Some embodiments of the present disclosure are now described with reference to the drawings. In the drawings, like referenced numerals are used to refer to like elements throughout. In the following description, for purposes of explanation, numerous specific details are set forth in order to provide a more thorough understanding of the embodiments. In various cases, some embodiments may be practiced without these specific details, yet a person having ordinary skill in the art will recognize that such embodiments are within the metes and bounds of this disclosure.

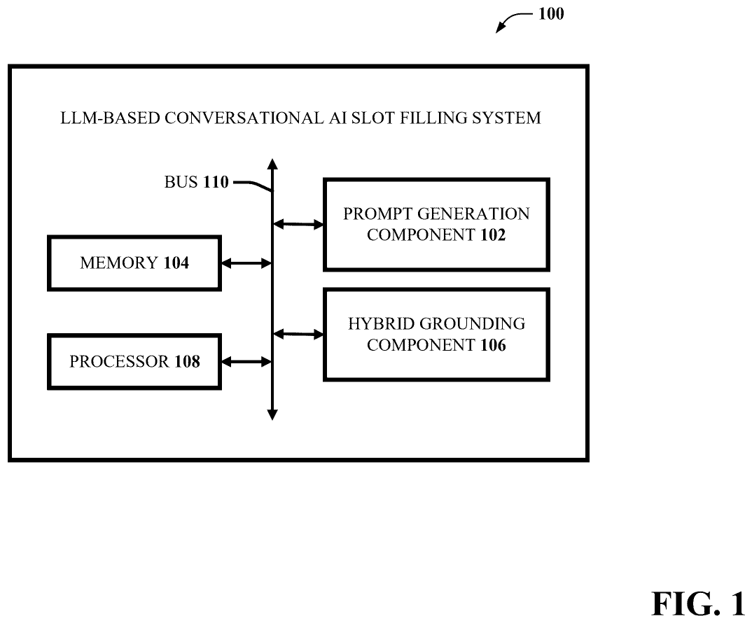

FIG. 1 illustrates an example system 100 for facilitating LLM-based conversational AI slot filling. The system 100 uses a prompt generation component, and a hybrid grounding component. The prompt generation component builds, based on usage logs, a ranking of slots, for filling in conversations, and dynamically and incrementally prompts a subset of slots based on the ranking for a virtual assistant. The hybrid grounding component grounds information pertaining to the subset of slots for the virtual assistant. The hybrid grounding component further utilizes intent determination to fill one or more of the slots.

Aspects of systems (e.g., systems 100, 200, and the like), apparatuses, or processes in various embodiments of the present disclosure can constitute one or more machine-executable components embodied within one or more machines. For example, the components may be embodied in one or more computer readable mediums (or media) associated with one or more machines. Such components, when executed by the one or more machines (e.g., computers, computing devices, virtual machines, etc.) can cause the machines to perform the operations described. System 100 may comprise a prompt generation component 102, a memory 104, a hybrid grounding component 106, a processor 108, and a system bus 110.

The system 100 and/or the components of the system 100 may use hardware and/or software to solve problems that are highly technical in nature. The system 100 solves problems that are not abstract and that cannot be performed as a set of mental acts by a human. Further, some of the processes may be performed by specialized computers for carrying out defined tasks related to LLM-based conversational AI slot filling. The system 100 and/or components of the system 100 may be employed to solve new problems that arise through advancements in technologies. The system 100 may provide technical improvements to LLM-based conversational AI slot filling by increasing reliability, accuracy, format precision, control and visibility when filling in slots, and by reducing response time and costs.

The system 100 may include a processor 108. In some embodiments, the processor 108 may execute a component or subcomponent associated with the system 100. Components or subcomponents associated with the system 100 may include one or more machine readable, writable, and/or executable instructions. In some embodiments, the system 100 may include a memory 104, and the memory 104 may store one or more components and/or subcomponents associated with the system 100. In some embodiments, the processor 108 may execute a component stored in the memory 104.

In some embodiments, the system 100 may include a computer-readable memory 104 that may be operably connected to the processor 108. The memory 104 may store computer-executable instructions that, upon execution by the processor 108, may cause the processor 108 and/or one or more other components of the system 100 (e.g., the prompt generation component 102, and/or the hybrid grounding component 106) to perform one or more actions. In some embodiments, the memory 104 may store computer-executable components (e.g., the prompt generation component 102, and/or the hybrid grounding component 106).

The system 100 and/or a component thereof as described herein may be communicatively, electrically, operatively, optically, and/or otherwise coupled to one another via a bus 110. The bus 110 may include one or more of a memory bus, memory controller, peripheral bus, external bus, local bus, and/or another type of bus that may employ one or more bus architectures. In some embodiments, the system 100 may be coupled (e.g., communicatively, electrically, operatively, optically, and/or the like) to one or more external systems (e.g., an electrical output production system, one or more output targets, an output target controller, and/or the like). In some embodiments, the system 100 may be coupled to one or more external sources, and/or devices (e.g., classical computing devices, communication devices, and/or like devices), such as via a network. In some embodiments, one or more of the components of the system 100 may reside in the cloud and/or locally in a local computing environment (e.g., at one or more specified locations).

In addition to the processor 108 and/or the memory 104 described above, the system 100 may include one or more computer and/or machine readable, writable, and/or executable components and/or instructions. When executed by the processor 108, these components and/or instructions may enable performance of one or more operations defined by the component(s) and/or instruction(s).

In various embodiments, the prompt generation component 102 performs the ranking by employing a machine learning model with an objective function of predicting the subset of slots to prompt given a current conversation and a frequency of slots filled on previous utterances. In some embodiments, the prompt generation component 102 builds the ranking of slots based at least in part on usage logs. In various embodiments, the prompt generation component 102 optimizes the system to reduce load and runtime latency, and to limit hallucinations. According to some embodiments, instead of prompting the LLM for all slots each time, the prompt generation component 102 fills in slots in an incremental, accumulative manner.

In some embodiments, the hybrid grounding component 106 determines at least one of: detected intent, detected entities, context of a conversation, session history, goal statement, format constraints regarding one or more slots, business policy constraints, application programming interface (API) call or environment information, previous error results, or feedback from a human user. In some embodiments, the hybrid grounding component 106 integrates natural language processing results of a trained virtual assistant into the grounding of information pertaining to respective slots.

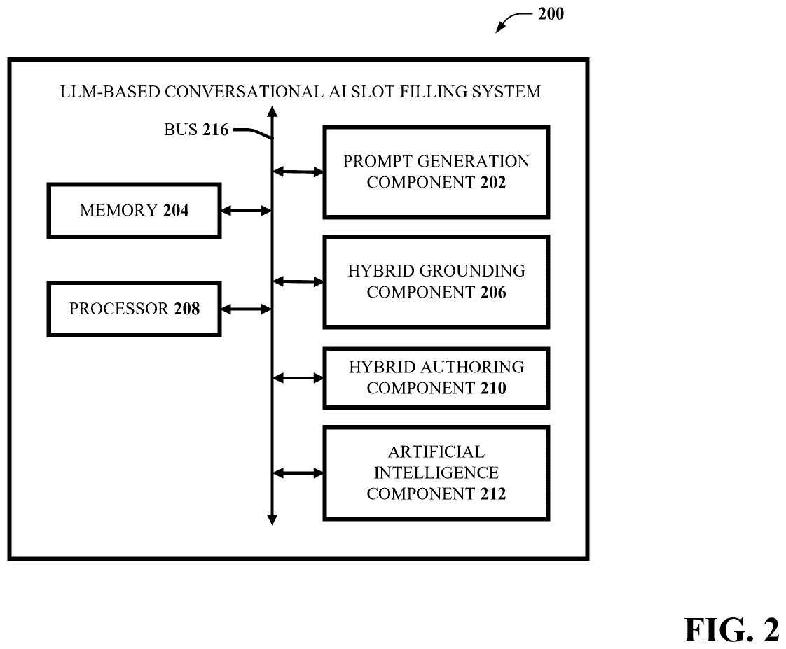

FIG. 2 illustrates an example system 200 that can facilitate LLM-based conversational AI slot filling. The system 200 uses a prompt generation component 202, a hybrid grounding component 206, a hybrid authoring component 210, and an artificial intelligence component 212. The system 200 may also include a memory 204, a processor 208, and a system bus 216. Description of like components has been omitted for the sake of brevity.

In various embodiments, hybrid authoring component 210 generates steps for the virtual assistant to follow.

In various embodiments, artificial intelligence component 212 trains a large language model to detect the grounded information. In some embodiments, the artificial intelligence component 212 utilizes the detected information to fill slots.

The systems and/or devices are described herein with respect to interaction between one or more components. Such systems and/or components may include the components and/or sub-components specified therein, one or more of the specified components and/or sub-components, and/or additional components. Sub-components may be implemented as components communicatively coupled to other components rather than included within parent components. One or more components and/or sub-components may be combined into a single component providing aggregate functionality. The components may interact with one or more other components not specifically described herein for the sake of brevity but known by those of skill in the art.

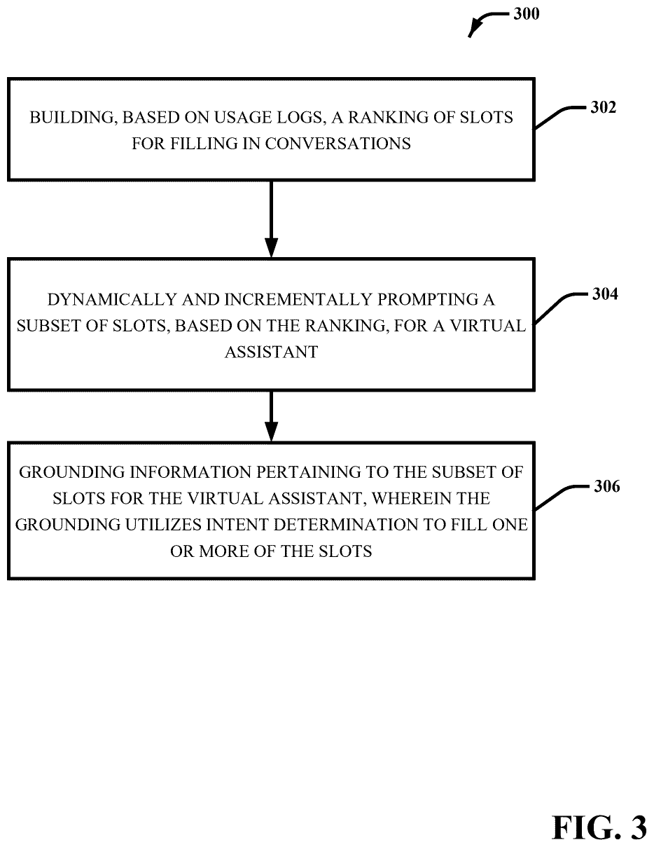

FIG. 3 illustrates an example computer-implemented method 300 that utilizes a processor that executes computer executable components stored in memory to facilitate LLM-based conversational AI slot filling. In some embodiments, a ranking of slots for filling in conversations is built based on usage logs. In various embodiments, a subset of slots are dynamically and incrementally prompted, based on the ranking, for a virtual assistant. In some embodiments, information pertaining to the subset of slots is grounded for the virtual assistant. In various embodiments, the grounding utilizes intent determination to fill one or more of the slots.

The computer-implemented method 300 starts by building 302, based on usage logs, a ranking of slots for filling in conversations. The method 300 continues by dynamically and incrementally prompting 304, based on the ranking, a subset of slots for a virtual assistant. The slot filling method 300 continues by grounding 306, information pertaining to the subset of slots for the virtual assistant, wherein the grounding utilizes intent determination to fill one or more of the slots.

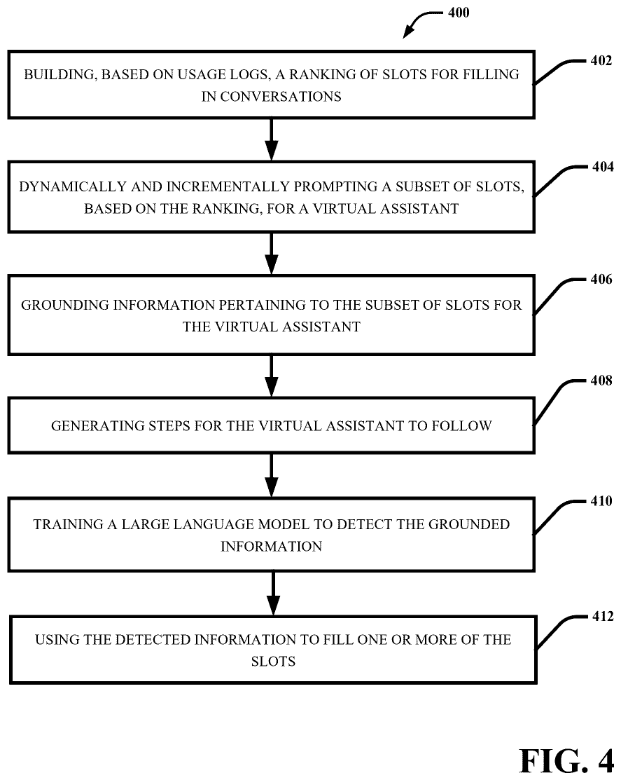

FIG. 4 illustrates an example computer-implemented method 400 that utilizes a processor that executes computer executable components stored in memory to facilitate LLM-based conversational AI slot filling. In some embodiments, a ranking of slots for filling in conversations is built based on usage logs. In various embodiments, a subset of slots are dynamically and incrementally prompted, based on the ranking, for a virtual assistant. In some embodiments, information pertaining to the subset of slots is grounded for the virtual assistant. In various embodiments, the grounding utilizes intent determination to fill one or more of the slots. In some embodiments, steps for the virtual assistant for follow are generated. In various embodiments, a large language model is trained to detect the grounded information. In some embodiments, the detected information is used to fill one or more of the slots.

The computer-implemented method 400 starts by building 402, based on usage logs, a ranking of slots for filling in conversations. The method 400 continues by dynamically and incrementally prompting 404, based on the ranking, a subset of slots for a virtual assistant. The method 400 continues by grounding 406, information pertaining to the subset of slots for the virtual assistant, wherein the grounding utilizes intent determination to fill one or more of the slots. The method 400 continues by generating 408 steps for the virtual assistant to follow. The method 400 then continues by training 410 a large language model to detect the grounded information. The slot filling method 400 then continues by using 412 the detected information to fill one or more of the slots.

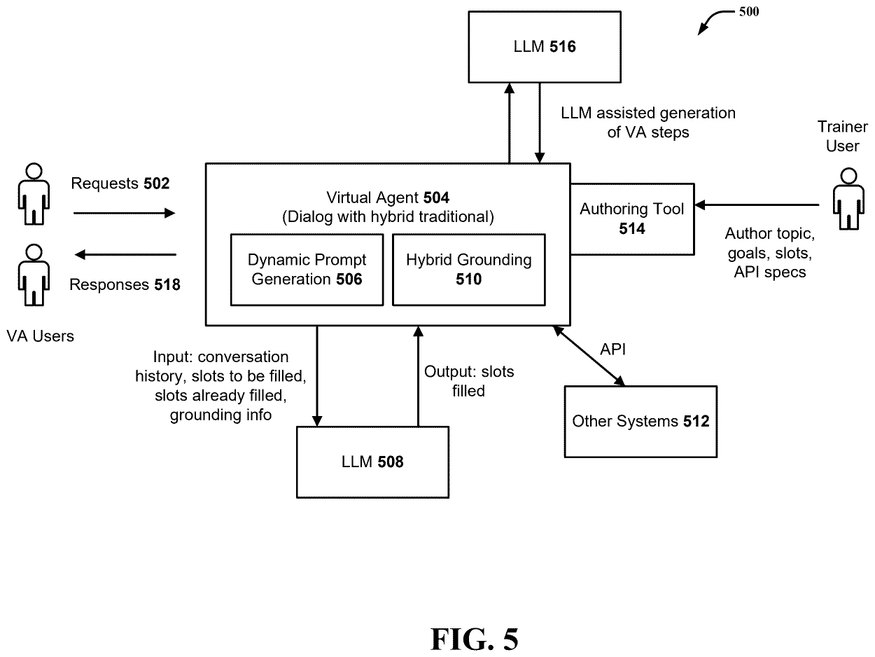

FIGS. 5-9 illustrate example flow diagrams of dynamic prompt generation architecture for carrying out various limitations of various embodiments described herein.

FIG. 5 illustrates an example hybrid authoring experience comprising dialog with hybrid traditional slot filling architecture 500 that allows users to build from scratch or use previous existing content. The example architecture includes dynamic prompt generation based on existing dialogue runtime, hybrid grounding, and hybrid authoring. The example architecture uses the information designers already provide for gathering information, thereby adding control and visibility for when LLM fills in slots. As a designer evolves virtual assistant, with LLMs the designer can give a more natural description of the steps and slots her VA needs to fill. The LLM is therefore also called at authoring time. A user request 502 is transmitted to the virtual agent 504. The virtual agent 504 then utilizes dynamic prompt generation 506 to provide inputs to the LLM 508. The inputs may comprise: conversation history, slots to be filled, slots already filled, grounding information, etc. The LLM 508 then provides outputs in the form of filled slots back to the virtual agent 504. The virtual agent 504 utilizes hybrid grounding 510 to call to other systems in order to produce a final set of information. A user can interact with the final set of information using authoring tool 514, and assisted by LLM 516. Final responses 518 are then provided back to the user.

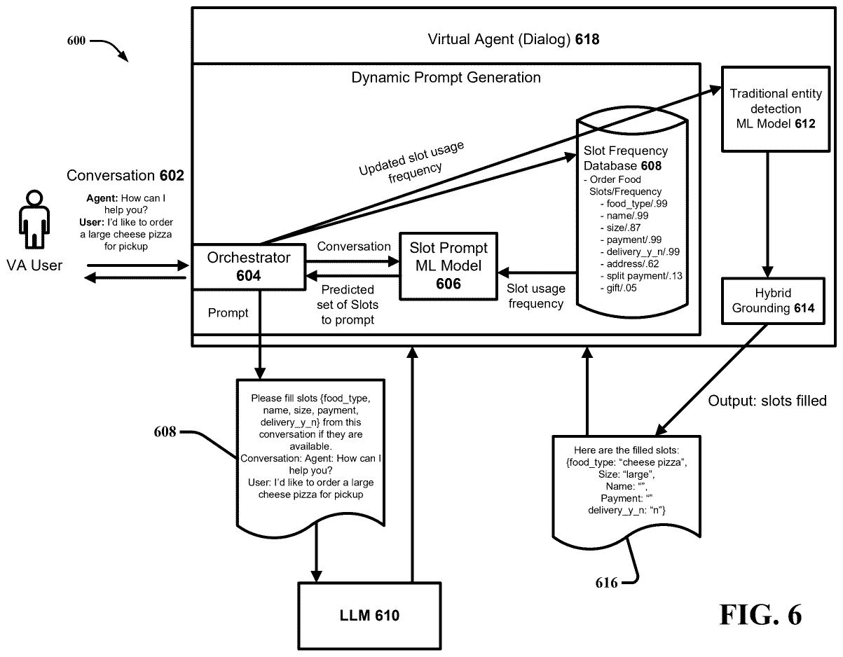

FIG. 6 illustrates an example dynamic prompt generation architecture 600 that enables slot prompt optimization based on usage. Instead of prompting the LLM for all slots each time, the example architecture fills the slots in an incremental, accumulative manner. The example architecture further builds a ranking of slots based on usage logs, and prompts slots based on ranking. This ranking may be a standard ML model with the objective function of predicting which slots to prompt given the conversation and frequency of slots filled on previous utterances. A user interacts 602 with the virtual agent 614. The conversation is sent to orchestrator 604. Orchestrator 604 sends the conversation to slot prompt model 606. Slot prompt model 606 calls information pertaining to slot usage frequency from the slot frequency database 608. Slot prompt model 606 uses the slot frequency information to generate a predicted set of slots to prompt, which are then returned to orchestrator 604. Orchestrator 604 then provides the set of slots to the LLM 608 and instructs LLM 608 to fill the predicted set of slots. LLM 608 uses the slot frequency information to fill the predicted set of slots. Orchestrator 604 concurrently calls to traditional entity detection ML model 610. Traditional entity detection ML model 610 utilizes hybrid grounding 612 to generate an output of filled slots, which are then returned to the virtual agent 614.

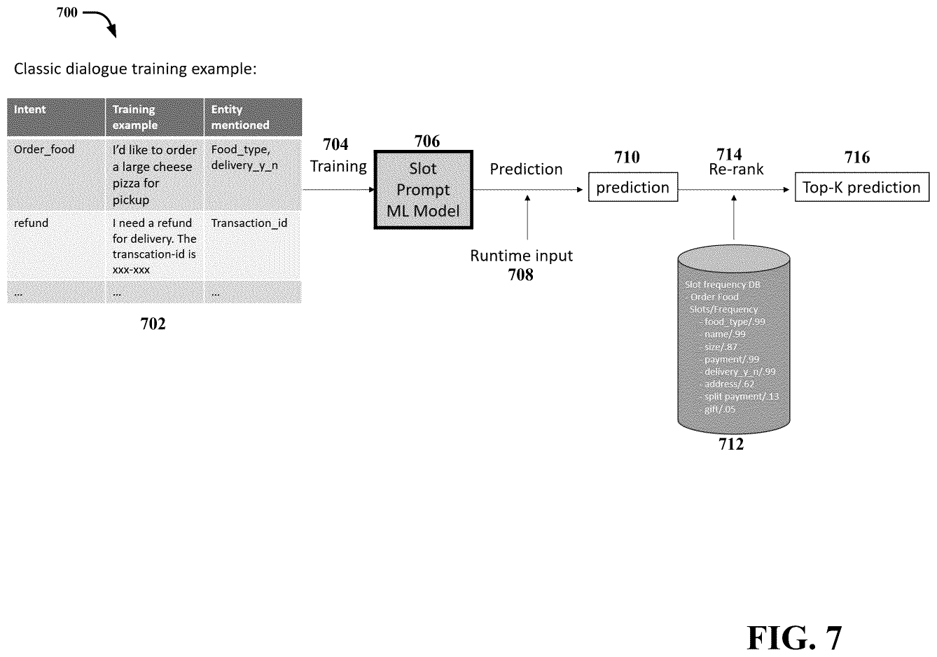

FIG. 7 illustrates an example prompt generation and slot prediction architecture 700 that uses dynamic prompt generation. In this example FIG. 7, known user data 702 from previous user interactions is collected. Data 702 is labelled according to user intent, known user input (training example), and entities mentioned. For example, a user may have provided the input “I'd like to order a large cheese pizza for pickups.” From this input, a user intent “Order_food” could be determined. Entities mentioned could include “Food_type,” which would be “pizza,” and “delivery_y_n,” which would be “no.” From this known user data 702 it is possible to generate correlations pertaining to entity detection. More specifically, from the known user data 702, it is possible to make predictions of relevant entities given a user input. From the example illustrated above, given the user input “I'd like to order a large cheese pizza for pickups,” it would be possible to predict that entities “Food_type” and “delivery_y_n” would be called. With a sufficiently large dataset 702, it is possible to train 704 a slot prompt model 706 to predict 710 a ranked list of entities based upon a given user input. The slot prompt model 706 further utilizes runtime input 708 to refine the prediction 710. The prediction 710 is supplanted with slot frequency information from a database 712 to re-rank 714 the predicted list of entities 710 based upon slot frequency. For example, entities within a given a list of predicted entities 710 may be assigned weight based upon the slot frequency information of database 712. Based upon the assigned weight, the ranking of entities within the list 710 is revised 714 in order to generate a revised top-K prediction 716. It is also possible that entities within database 712 were not present in the initially prediction list 710. In such case, entities from database 712 may be added to produce prediction list 710 revised top-K prediction 716.

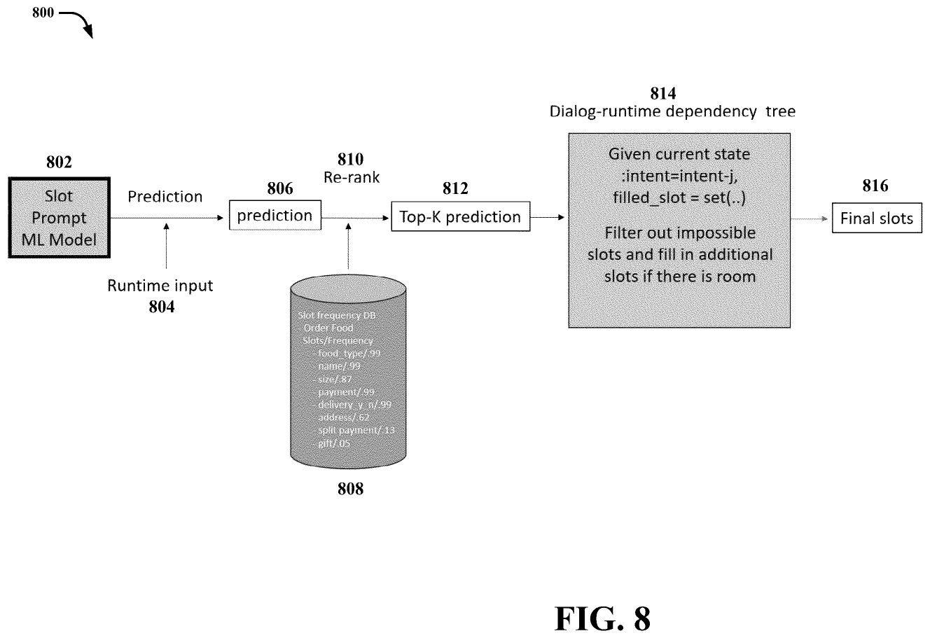

FIG. 8 illustrates an example architecture 800 for prompt generation and slot predictions. Steps 802, 804, 806, 810, and 812 of FIG. 8 may be likened to steps 702 through 716 of FIG. 7. Repeated description of like elements has been omitted for the sake brevity. Once a revised top-K prediction 812 is generated (for example, using the dynamic prompt generation and slot prediction architecture of FIG. 7 described above), impossible solutions are filtered out 814 of the top-K predictions 812 based on dialogue-runtime dependency and detected user intent. Given a revised top-K prediction 812, it is possible to further refine the predictions 814 before producing a final set of slots 816. Once impossible solutions are filtered 814 from the top-K predictions 812, additional slots can be filled if there is room. It will be appreciated that the desired number of final slots produced 816 will depend upon the limitations of the LLM (i.e., how many slots the LLM could handle), which is a heuristic that could be discovered. A final set of slots 816 is then generated.

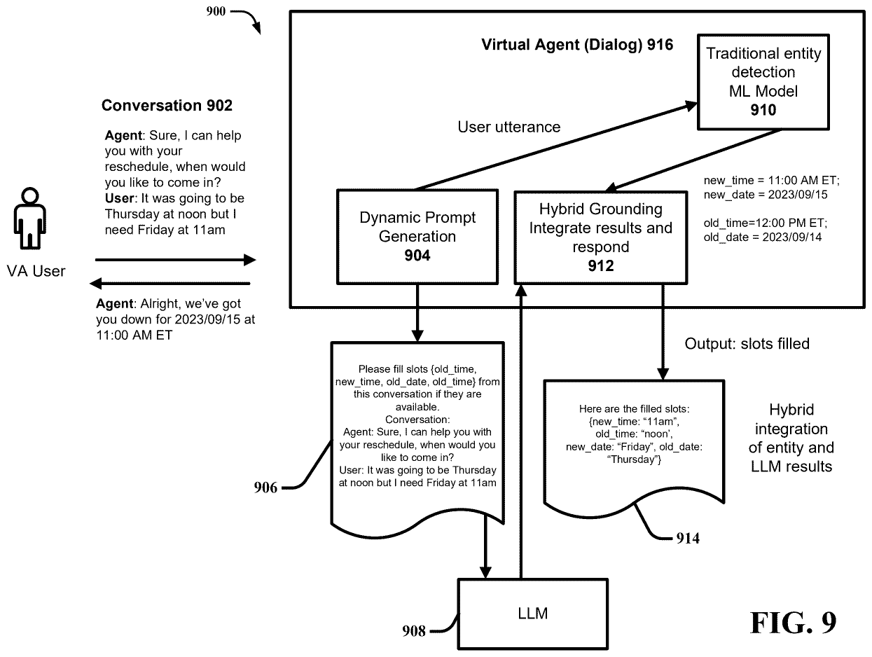

FIG. 9 illustrates an example architecture 900 for hybrid integration and grounding systems. The virtual agent system solves the slot filling problem by using an LLM and improves effectiveness through grounding to information uniquely available to the VA. The grounding information can include detected intent, detected entities, context of the conversation, session history, goal statement, format constraints on each slot, business policy constraints, API call/environment information, previous error results, and feedback from the human user. By leveraging grounding, the slots can be predicted with greater accuracy and can be more readily used to perform tasks in the VA. In cases where the conversation designer already has a trained VA, the hybrid system can use both the LLM results and the traditional natural language processing (“NLP”) results. The example architecture does not require that the user start from scratch in order to fill in slots. After a slot is filled, the matched information can sometimes be “corrected” by the user interacting with the VA. This may be accomplished via a subsequent user statement that invalidates what was indicated in a previous turn, or by an explicit correction to a confirmation message from the VA. A common VA design pattern is to present the filled slot information to the user (digital on screen or voice by phone, etc.) for confirmation. Before proceeding with a task, the user may need to first confirm the information is correct. This information from the user can serve as context to further ground a subsequent call to the LLM. For example: VA passes human's input to LLM; LLM responds slots filled in the conversation; human makes a statement or gestures in a way that invalidates a filled slot; VA calls LLM (may be a second LLM) with original context and new user statement and asks for a correction; LLM responds with corrected slot values; human confirms and the VA performs the tasks. Example architecture 900 allows users to engage a virtual agent 918 in conversation 902. The virtual agent 918 uses dynamic prompt generation 904 to generate a predicted set of slots 906 for an LLM 908 to fill. The LLM 908 fills the predicted set of slots 906 and returns the filled slots to the virtual agent 918. The virtual agent 918 concurrently uses dynamic prompt generation 904 to send the user utterance contained in conversation 902 to a traditional entity detection model 910. Traditional entity detection model 910 generates and fills slots based upon the user utterance from the conversation 902. The virtual agent 916 then uses hybrid grounding 912 to integrate the results of the LLM 908 and the traditional entity detection model 910. Based upon the integration of the results via hybrid grounding 912, the virtual agent 916 outputs filled slots 914. It will be appreciated that a user could have a heuristic to trust LLM 908 over the traditional entity detection model 910, and vice versa. For example, if an LLM 908 is relatively new, a user may place greater confidence in the results of the traditional entity detection model 910, and thus the virtual agent 916 would place greater weight on the results of the traditional entity detection model 910 when performing the hybrid grounding 912.

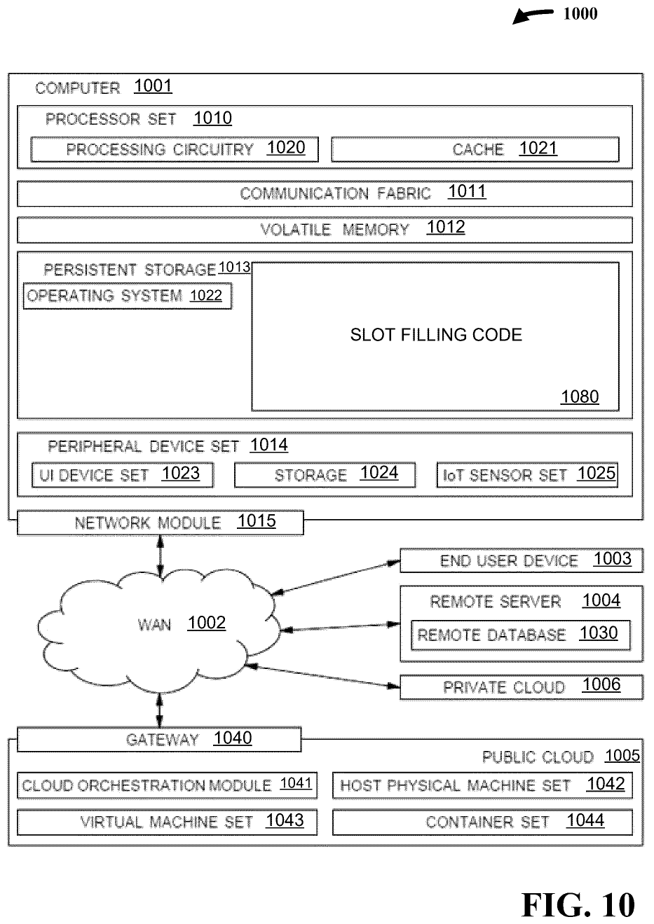

FIG. 10 and the following discussion are intended to provide a brief, general description of a suitable computing environment 1000 in which some embodiments described herein can be implemented. For example, various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks can be performed in reverse order, as a single integrated step, concurrently or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium can be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1000 contains an example of an environment for the execution of at least some of the computer code involved in performing the inventive methods, such as filling slots with slot filling code 1080. In addition to block 1080, computing environment 1000 includes, for example, computer 1001, wide area network (WAN) 1002, end user device (EUD) 1003, remote server 1004, public cloud 1005, and private cloud 1006. In this embodiment, computer 1001 includes processor set 1014 (including processing circuitry 1020 and cache 1021), communication fabric 1011, volatile memory 1012, persistent storage 1013 (including operating system 1022 and block 1045, as identified above), peripheral device set 1014 (including user interface (UI), device set 1023, storage 1024, and Internet of Things (IoT) sensor set 1025), and network module 1015. Remote server 1004 includes remote database 1030. Public cloud 1005 includes gateway 1040, cloud orchestration module 1041, host physical machine set 1042, virtual machine set 1043, and container set 1044.

COMPUTER 1001 can take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1030. As is well understood in the art of computer technology, and depending upon the technology, performance of a computer-implemented method can be distributed among multiple computers and/or between multiple locations. On the other hand, in this presentation of computing environment 1000, detailed discussion is focused on a single computer, specifically computer 1001, to keep the presentation as simple as possible. Computer 1001 can be located in a cloud, even though it is not shown in a cloud in FIG. 10. On the other hand, computer 1001 is not required to be in a cloud except to any extent as can be affirmatively indicated.

PROCESSOR SET 1010 includes one, or more, computer processors of any type now known or to be developed in the future. Processing circuitry 1020 can be distributed over multiple packages, for example, multiple, coordinated integrated circuit chips. Processing circuitry 1020 can implement multiple processor threads and/or multiple processor cores. Cache 1021 is memory that is located in the processor chip package(s) and is typically used for data or code that should be available for rapid access by the threads or cores running on processor set 1010. Cache memories are typically organized into multiple levels depending upon relative proximity to the processing circuitry. Alternatively, some, or all, of the cache for the processor set can be located “off chip.” In some computing environments, processor set 1010 can be designed for working with qubits and performing quantum computing.

Computer readable program instructions are typically loaded onto computer 1001 to cause a series of operational steps to be performed by processor set 1010 of computer 1001 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1021 and the other storage media discussed below. The program instructions, and associated data, are accessed by processor set 1010 to control and direct performance of the inventive methods. In computing environment 1000, at least some of the instructions for performing the inventive methods can be stored in block 1045 in persistent storage 1013.

COMMUNICATION FABRIC 1011 is the signal conduction path that allows the various components of computer 1001 to communicate with each other. Typically, this fabric is made of switches and electrically conductive paths, such as the switches and electrically conductive paths that make up busses, bridges, physical input/output ports and the like. Other types of signal communication paths can be used, such as fiber optic communication paths and/or wireless communication paths.

VOLATILE MEMORY 1012 is any type of volatile memory now known or to be developed in the future. Examples include dynamic type random access memory (RAM) or static type RAM. Typically, the volatile memory is characterized by random access, but this is not required unless affirmatively indicated. In computer 1001, the volatile memory 1012 is located in a single package and is internal to computer 1001, but, alternatively or additionally, the volatile memory can be distributed over multiple packages and/or located externally with respect to computer 1001.

PERSISTENT STORAGE 1013 is any form of non-volatile storage for computers that is now known or to be developed in the future. The non-volatility of this storage means that the stored data is maintained regardless of whether power is being supplied to computer 1001 and/or directly to persistent storage 1013. Persistent storage 1013 can be a read only memory (ROM), but typically at least a portion of the persistent storage allows writing of data, deletion of data and re-writing of data. Some familiar forms of persistent storage include magnetic disks and solid-state storage devices. Operating system 1022 can take several forms, such as various known proprietary operating systems or open-source Portable Operating System Interface type operating systems that employ a kernel. The code included in block 1045 typically includes at least some of the computer code involved in performing the inventive methods.

PERIPHERAL DEVICE SET 1014 includes the set of peripheral devices of computer 1001. Data communication connections between the peripheral devices and the other components of computer 1001 can be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1023 can include components such as a display screen, speaker, microphone, wearable devices (such as goggles and smart watches), keyboard, mouse, printer, touchpad, game controllers, and haptic devices. Storage 1024 is external storage, such as an external hard drive, or insertable storage, such as an SD card. Storage 1024 can be persistent and/or volatile. In some embodiments, storage 1024 can take the form of a quantum computing storage device for storing data in the form of qubits. In embodiments where computer 1001 is required to have a large amount of storage (for example, where computer 1001 locally stores and manages a large database) then this storage can be provided by peripheral storage devices designed for storing large amounts of data, such as a storage area network (SAN) that is shared by multiple, geographically distributed computers. IoT sensor set 1025 is made up of sensors that can be used in Internet of Things applications. For example, one sensor can be a thermometer, and another sensor can be a motion detector.

NETWORK MODULE 1015 is the collection of computer software, hardware, and firmware that allows computer 1001 to communicate with other computers through WAN 1002. Network module 1015 can include hardware, such as modems or Wi-Fi signal transceivers, software for packetizing and/or de-packetizing data for communication network transmission, and/or web browser software for communicating data over the internet. In some embodiments, network control functions and network forwarding functions of network module 1015 are performed on the same physical hardware device. In other embodiments (for example, embodiments that utilize software-defined networking (SDN)), the control functions and the forwarding functions of network module 1015 are performed on physically separate devices, such that the control functions manage several different network hardware devices. Computer readable program instructions for performing the inventive methods can typically be downloaded to computer 1001 from an external computer or external storage device through a network adapter card or network interface included in network module 1015.

WAN 1002 is any wide area network (for example, the internet) capable of communicating computer data over non-local distances by any technology for communicating computer data, now known or to be developed in the future. In some embodiments, the WAN can be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1003 is any computer system that is used and controlled by an end user (for example, a customer of an enterprise that operates computer 1001) and can take any of the forms discussed above in connection with computer 1001. EUD 1003 typically receives helpful and useful data from the operations of computer 1001. For example, in a hypothetical case where computer 1001 is designed to provide a recommendation to an end user, this recommendation would typically be communicated from network module 1015 of computer 1001 through WAN 1002 to EUD 1003. In this way, EUD 1003 can display, or otherwise present, the recommendation to an end user. In some embodiments, EUD 1003 can be a client device, such as thin client, heavy client, mainframe computer and/or desktop computer.

REMOTE SERVER 1004 is any computer system that serves at least some data and/or functionality to computer 1001. Remote server 1004 can be controlled and used by the same entity that operates computer 1001. Remote server 1004 represents the machine(s) that collect and store helpful and useful data for use by other computers, such as computer 1001. For example, in a hypothetical case where computer 1001 is designed and programmed to provide a recommendation based on historical data, then this historical data can be provided to computer 1001 from remote database 1030 of remote server 1004.

PUBLIC CLOUD 1005 is any computer system available for use by multiple entities that provides on-demand availability of computer system resources and/or other computer capabilities, especially data storage (cloud storage) and computing power, without direct active management by the scale. The direct and active management of the computing resources of public cloud 1005 is performed by the computer hardware and/or software of cloud orchestration module 1041. The computing resources provided by public cloud 1005 are typically implemented by virtual computing environments that run on various computers making up the computers of host physical machine set 1042, which is the universe of physical computers in and/or available to public cloud 1005. The virtual computing environments (VCEs) typically take the form of virtual machines from virtual machine set 1043 and/or containers from container set 1044. It is understood that these VCEs can be stored as images and can be transferred among and between the various physical machine hosts, either as images or after instantiation of the VCE. Cloud orchestration module 1041 manages the transfer and storage of images, deploys new instantiations of VCEs and manages active instantiations of VCE deployments. Gateway 1040 is the collection of computer software, hardware and firmware allowing public cloud 1005 to communicate through WAN 1002.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1006 is similar to public cloud 1005, except that the computing resources are only available for use by a single enterprise. While private cloud 1006 is depicted as being in communication with WAN 1002, in other embodiments a private cloud can be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1175 and private cloud 1176 are both part of a larger hybrid cloud. The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of some of the embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of some of the embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In some embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of some of the embodiments described herein.

Aspects of some of the embodiments described herein are described with reference to flowchart illustrations and/or block diagrams of methods, apparatus (systems), and computer program products according to some embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to some embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that some of the embodiments herein also can be implemented at least partially in parallel with one or more other program modules. Generally, program modules include routines, programs, components and/or data structures that perform particular tasks and/or implement particular abstract data types. Moreover, the described computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the various embodiments, but one of ordinary skill in the art can recognize that many further combinations and/or permutations of the various embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a processor that executes computer executable components stored in memory, wherein the computer executable components comprise:
a prompt generation component that builds, based on usage logs, a ranking of slots, for filling in conversations, and dynamically and incrementally prompts a subset of slots based on the ranking for a virtual assistant; and
a hybrid grounding component that grounds information pertaining to the subset of slots for the virtual assistant, wherein the hybrid grounding component utilizes intent determination to fill one or more of the slots.

2. The system of claim 1, further comprising a hybrid authoring component that generates steps for the virtual assistant to follow.

3. The system of claim 1, further comprising an artificial intelligence component that trains a large language model to detect the grounded information.

4. The system of claim 3, wherein the artificial intelligence component utilizes the detected information to fill slots.

5. The system of claim 1, wherein the prompt generation component performs the ranking by employing a machine learning model with an objective function of predicting the subset of slots to prompt given a current conversation and a frequency of slots filled on previous utterances.

6. The system of claim 1, wherein the hybrid grounding component determines at least one of: detected intent, detected entities, context of a conversation, session history, goal statement, format constraints regarding one or more slots, business policy constraints, application programming interface (API) call or environment information, previous error results, or feedback from a human user.

7. The system of claim 1, wherein the hybrid grounding component integrates natural language processing results of a trained virtual assistant into the grounding of information pertaining to respective slots.

8. The system of claim 1, wherein the prompt generation component builds the ranking of slots based at least in part on usage logs.

9. A computer-implemented method that utilizes a processor that executes computer executable components stored in memory to perform the following acts:
building, based on usage logs, a ranking of slots, for filling in conversations, and dynamically and incrementally prompting a subset of slots, based on the ranking, for a virtual assistant; and
grounding information pertaining to the subset of slots for the virtual assistant, wherein the grounding utilizes intent determination to fill one or more of the slots.

10. The method of claim 9, further comprising generating steps for the virtual assistant to follow.

11. The method of claim 9, further comprising training a large language model to detect the grounded information.

12. The method of claim 11, further comprising using the detected information to fill the slots.

13. The method of claim 9, further comprising predicting which slots to prompt.

14. The method of claim 10, wherein the predicting of slots to prompt is based at least in part on a current conversation and a frequency of slots filled on previous utterances.

15. The method of claim 9, further comprising determining at least one of: detected intent, detected entities, context of a conversation, session history, goal statement, format constraints on each slot, business policy constraints, API call/environment information, previous error results, and feedback from a human user.

16. The method of claim 9, wherein the virtual assistant fills the slots.

17. The method of claim 10, wherein the slots are filled in an incremental, accumulative manner.

18. The method of claim 10, wherein a user confirms that the slots were filling in correctly.

19. The method of claim 10, wherein a user manually corrects an error made during the slot filling.

20. A computer program product comprising a computer readable storage medium having program instructions embodied therewith, the program instructions executable by a processor to cause the processor to:
build a ranking of slots and prompt slots basted on the ranking;
ground information pertaining to the slots;
train a large language model to detect the grounded information;
use the detected information to generate steps for a virtual assistant to follow to fill the slots.
